(19) United States
(12) Patent Application Publication
(10) Pub. No.: US 2015/0142261 A1
(43) Pub. Date: May 21, 2015

(54) METHOD AND SYSTEMS FOR AN AUDIO PASS INTEGRATED VEHICLE SAFETY SYSTEM

(71) Applicant: Mickey Wright, JR., Atlanta, GA (US)

(72) Inventor: Mickey Wright, JR., Atlanta, GA (US)

(21) Appl. No.: 14/082,744

(22) Filed: Nov. 18, 2013

(51) Int. Cl. B60W 50/00

(52) U.S. Cl. CPC B60W 50/00
USPC 701/36

(57) ABSTRACT

A system and method are disclosed herein for providing an integrated safety system for a vehicle. The system comprises a vehicle audio and infotainment system having software code to allow a mobile device to connect to it such that certain features of the mobile device can be controlled by the vehicle's audio and infotainment system. The system allows the mobile device to be authenticated with the vehicle such that the mobile device can also control the vehicle's ignition, security and audio and infotainment systems. The system only allows the mobile device to be operable within the vehicle via the vehicle's integrated audio and infotainment controls. The system prevents the use of certain features of the audio and infotainment system if certain safety precautions are not taken. The system determines if a passenger has properly engaged the restrain system before the audio and infotainment system becomes operable for a user.

### FIELD OF THE INVENTION

The present invention relates generally to integrated vehicle safety systems and, more particularly, to methods and systems for providing an integrated vehicle safety system for preventing texting while driving, as well as, promoting seatbelt use and safe driving habits.

### BACKGROUND OF THE INVENTION

The use of mobile devices has become ubiquitous. Unfortunately, using mobile devices while driving can be particularly dangerous. This Is especially true for sending text messages, referred to in the industry as short message service (“SMS”) or media messaging service (“MMS”). Drivers who send these types of messages while operating a motor vehicle have contributed to numerous accidents due to their distracted driving. In fact, numerous government agencies around the world have enacted laws to prevent or restrict mobile device use while driving a motor vehicle. In many jurisdictions, drivers are only allowed to use mobile devices if they can be pared with a hands free device or a hands free vehicle infotainment system. Auto manufactures have begun to address this problem by offering vehicle infotainment systems that connect with a driver's mobile device. Many of the systems are capable of pairing with the driver's mobile device for reading incoming text messages, streaming media to the vehicle's infotainment system, and operating a vehicle's security system. Unfortunately, these systems require to the driver to voluntarily pair their devices with the vehicle's infotainment system. However, because the user interface for some vehicle infotainment systems are designed so poorly, many drivers opt to simply use their devices as they normally would, without paring the device to the vehicle. Furthermore, the majority of older vehicles on the road do not offer these advanced infotainment systems that can pair with a mobile device and therefore, the user's mobile device cannot be paired with the vehicle.

It is even more difficult to get teenage drivers and young adults to restrain from sending texts and using their mobile devices while driving. It is also often times difficult to persuade teenagers and young adult drivers to engage their vehicle's safety systems by buckling their seatbelts. Therefore, when parents allow their inexperienced, teenage drivers behind the wheel of a vehicle; they are taking a risk that their child might be texting while driving, and even worse, driving without their seatbelt buckled. A system for requiring both hands free mobile device use and for encouraging teenagers to engage a vehicle's safety systems is needed to save lives and prevent accidents.

The embodiment's of the present invention meets one or more of the above-referenced needs as described herein in greater detail.

### SUMMARY OF THE INVENTION

The present invention relates generally to providing an integrated vehicle safety system for preventing texting while driving, as well as, promoting seat belt use and safe driving habits. Briefly described, aspects of the present invention include the following:

In a first aspect, the present embodiment provides a method for an integrated safety system for a vehicle. The integrated safety system comprising a vehicle audio and infotainment system, which comprises a computing device with wired and wireless connection capabilities. The vehicle audio and infotainment system is connected to a vehicle ignition system, a vehicle safety restraint system, a vehicle security system and a driver data recording system. Software code is provided to allow a mobile device to connect and control certain aspects of the vehicle's audio and infotainment system. The software code allows the mobile device to be authenticated with the vehicle's audio and infotainment systems such that the mobile device can control the vehicle's ignition, security and audio and infotainment systems. The system further comprises software code for a mobile device management system, which only allows the mobile device to be operable within the vehicle via the vehicle's integrated audio and infotainment controls. In a further embodiment, the vehicle audio and infotainment system in connection with the mobile device management system, allows the mobile device to be operated via the vehicle's voice audio control during vehicle operation. The mobile device management system can also allow the mobile device to control certain vehicle ignition and security systems. The mobile device management system further prevents the use of certain features of the audio and infotainment system if certain safety restraint systems are not engaged during vehicle operation. In a further embodiment, the Integrated safety system uses sensors for determining if a passenger has properly engaged the restrain system before the audio and infotainment system becomes operable for a user.

In a further aspect, embodiments of the integrated vehicle safety system use the vehicle's audio and infotainment system to introduce punitive operational delays if the vehicle is driven without the mobile device management system or if the vehicle's safety restraint systems are not engaged. The length of these operational delays can be user adjustable. In another embodiment, the integrated safety system employs the mobile device management system to disable handheld operation of certain features of the mobile device when the mobile device is stored within the vehicle. Alternatively, the mobile device may be stored in an integrated mobile device storage unit that stores and disables handheld operation of certain features of the mobile device. The mobile device management system can further disable handheld operation of certain features of the mobile device when the vehicle is in motion.

In a third aspect, the integrated safety system records driver and vehicle performance data for collecting driver and vehicle performance stats during vehicle operation. The driver data recording system can transfer vehicle performance data to the mobile device. Furthermore, the mobile device management system can produce a cellular or wireless network-jamming signal when the vehicle is in use.

The above features as well as additional features and aspects of the present invention are disclosed herein and will become apparent from the following description of preferred embodiments of the present invention.

This summary is provided to introduce a selection of aspects and concepts in a simplified form that are further described below in the detailed description. This summary is not intended to identify key features or essential features of the claimed subject matter, nor is it intended to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there Is shown in the drawings example constructions of the embodiments; however, the embodiments are not limited to the specific methods and instrumentalities disclosed. In the drawings:

FIG. 1 is a flow diagram of an exemplary embodiment of an integrated vehicle safety system according to an embodiment;

FIG. 2 is a flow diagram of an exemplary embodiment of an integrated vehicle safety system for preventing operation of certain mobile device features during vehicle operation according to an embodiment;

FIG. 3 is a flow diagram of an exemplary embodiment of an integrated vehicle safety system for recording driver and vehicle performance data during vehicle operation according to an embodiment;

FIGS. 4A-4B are an illustration of a vehicles audio and infotainment system display according to an exemplary embodiment;

FIG. 5 is an illustration of an integrated mobile device storage system according to an exemplary embodiment;

FIG. 6 is an illustration of the safety restraint and sensors according to an exemplary embodiment; and

FIG. 7 is an illustration of an exemplary computing device.

### DETAILED DESCRIPTION

Before the present methods and systems are disclosed and described in greater detail hereinafter, it is to be understood that the methods and systems are not limited to specific methods, specific components, or particular implementations. It is also to be understood that the terminology used herein is for the purpose of describing particular aspects and embodiments only and is not intended to be limiting.

As used in the specification and the appended claims, the singular forms “a,” “an,” and “the” include plural referents unless the context clearly dictates otherwise. Similarly, “optional” or “optionally” means that the subsequently described event or circumstance may or may not occur, and the description includes instances where the event or circumstance occurs and instances where it does not.

Throughout the description and claims of this specification, the word “comprise” and variations of the word, such as “comprising” and “comprises,” mean “Including but not limited to,” and are not Intended to exclude, for example, other components, integers or steps. “Exemplary” means “an example of” and is not intended to convey an indication of preferred or ideal embodiment. “Such as” is not used in a restrictive sense, but for explanatory purposes.

Disclosed herein are components that can be used to perform the disclosed methods and systems. It is understood that when combinations, subsets, interactions, groups, etc. of these components are disdosed that although specific reference to each various individual and collective combinations and permutations cannot be explicitly disclosed, each is specifically contemplated and incorporated herein, for all methods and systems. This applies to all aspects of this specification including, but not limited to, steps in disclosed methods. Thus; if there are a variety of additional steps that can be performed it is understood that each of the additional steps can be performed with any specific embodiment or combination of embodiments of the disclosed methods.

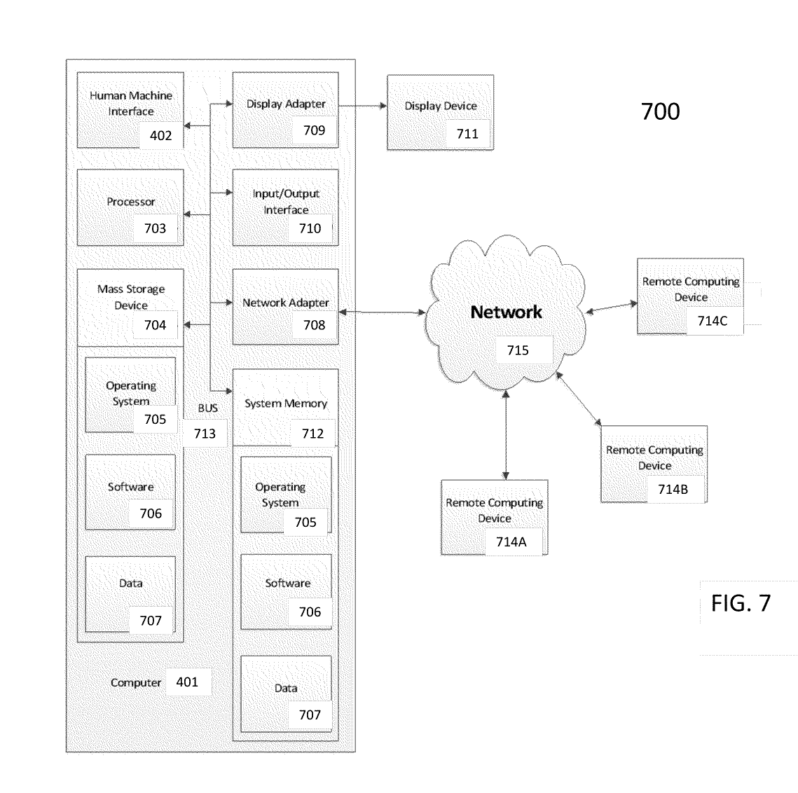

As will be appreciated by one skilled in the art, the methods and systems may take the form of an entirely new hardware embodiment, an entirely new software embodiment, or an embodiment combining new software and hardware aspects. Furthermore, the methods and systems may take the form of a computer program product on a computer-readable storage medium having computer-readable program instructions (e.g., computer software) embodied in the storage medium. In the exemplary embodiment both the mobile device and the vehicle's audio and infotainment system are computing devices. More particularly, the present methods and systems may take the form of web-implemented computer software. Any suitable computer-readable storage medium may be utilized including hard disks, non-volatile flash memory, CD-ROMs, optical storage devices, and/or magnetic storage devices. An exemplary computer system is detailed in the discussion of FIG. 7 below.

Embodiments of the methods and systems are described below with reference to block diagrams and flowchart illustrations of methods, systems, apparatuses and computer program products. It will be understood that each block of the block diagrams and flow illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems, such as a mobile device or vehicle audio and infotainment system, that perform the specified functions or steps, or combinations of special purpose hardware and computer instructions.

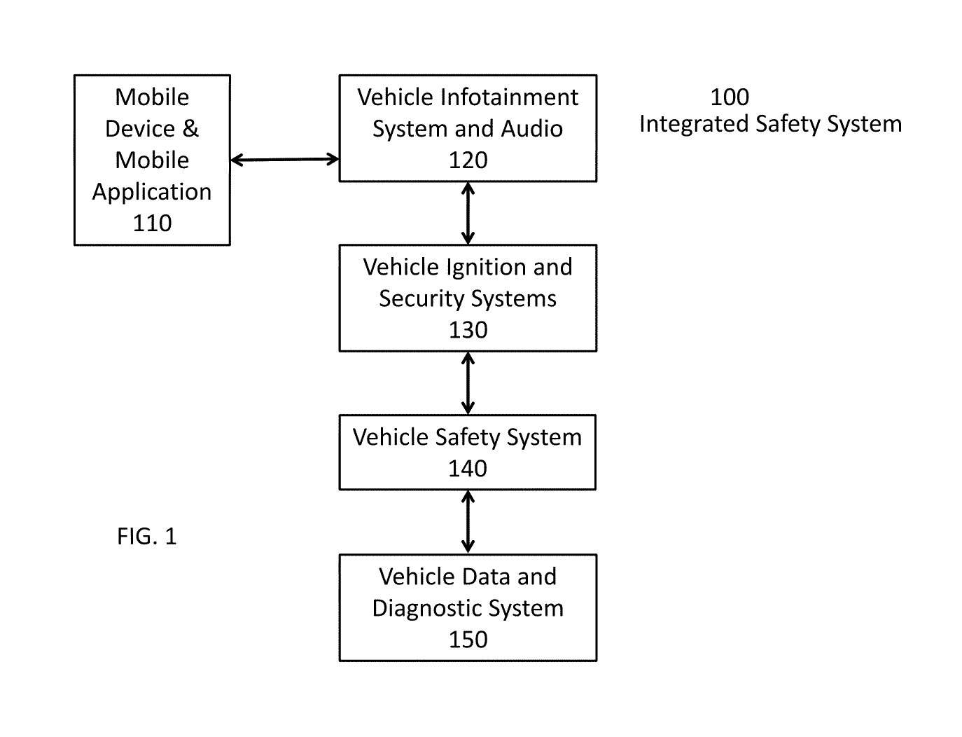

FIG. 1 is a flow diagram that illustrates the various aspects of an exemplary embodiment in which the present methods and systems can operate. The present disclosure relates to methods and systems for providing an integrated vehicle safety system employing both software applications operable on a driver's mobile device and operable on a vehicle's audio infotainment, safety systems and vehicle management systems. Those skilled in the art will appreciate that present methods may be used in systems that employ both digital and analog equipment. One skilled in the art will also appreciate that provided herein is a functional description and that the respective functions can be performed by software, hardware, or a combination of software and hardware.

Turning now to FIG. 1, a flow diagram of the integrated safety system 100 is illustrated. The integrated safety system 100 can include a number of separate components that act in relationship with each other. For example, a driver's mobile device is one component of the system. The mobile device is typically a smartphone computing device running any number of smartphone operating systems, including iOS by Apples® Corporation, Android® by Google Corporation, Blackberry OS® by Blackberry Corporation, Windows 8® by Microsoft Corporation, or any of the numerous other mobile device operating systems. A second component of the system is the vehicle's built-in computing devices. For example, the vehicle's audio and infotainment system provides navigation, radio control, climate control, mobile device Bluetooth® pairing, vehicle diagnostics and the like that are well known in the art. In an embodiment, both a driver's mobile device and the vehicle's onboard computing systems include software applications that allow the mobile device and the vehicle's onboard computing systems to communicate with each other such that the mobile device 110 can be used to control certain features of the vehicle and the vehicle can in turn, control certain features of the mobile device 110 through its onboard audio and infotainment system 120.

Beginning at step 110, the driver's mobile device contains a software application or a software application programming Interface (API) with the mobile device's operating system for communicating with a vehicle's onboard computing systems. In an exemplary embodiment, this application allows the mobile device 110 to connect or “pair” with the vehicle's onboard computing systems using Bluetooth, near field communications (NFC), wireless fidelity (Wi-Fi), ultra-wide band (UWB), and other wireless or hard-wired technologies as is known in the art. Once paired with vehicle, the mobile device 110 can be used as a “key” to control the vehicle's ignition and security systems 130. Therefore, the mobile device 110 can be used unlock the vehicle doors, open windows, turn on the vehicle's lights, climate control system, start the vehicle's ignition system, and perform other functions. Once inside the vehicle, the mobile device 110, in an exemplary embodiment, becomes a “child” under the control of the vehicle's on board computing systems as describe below.

The vehicle's onboard computing systems can be represented generally by the vehicle's audio and infotainment system 120. These systems 120 are becoming standard in newer vehicles and are often times, very similar in operation to mobile devices. For example, many vehicle audio and infotainment systems offer a number of applications (or “apps”) for listening to music, news, sports information and the like. These systems 120 also control climate, vehicle diagnostics, vehicle preferences, navigation and other features of a motor vehicle. Although the discussion here is related to the vehicle's audio and infotainment system 120, this discussion can include any of the vehicle's onboard computing systems induding the vehicle's engine management computer and other onboard electronic systems as is known in the art. The vehicles audio and infotainment system 120 may also be represented . by an aftermarket add-on that replaces or enhances a vehicle's existing audio and infotainment system 120. The audio and infotainment system 120, can be thought to represent the interface between the driver, the driver's mobile device 110 and the vehicle's onboard computing systems.

Similar to the discussion related to the mobile device 110 above, the vehicle's audio and infotainment system 120 contains software applications or API for controlling certain features of the mobile device 110 once the two systems are paired. For example, once inside the vehicle, the audio and infotainment system 120 may send a signal to the mobile device to disable operation of most of its input controls. The audio and infotainment system 120 can then require all control of the mobile device 110 to be directed through the vehicle's own internal input control systems, such that a driver can only operate the mobile device 110 within the vehicle by using the controls available through the vehicle's built in inputs. For example, in an embodiment, the audio and infotainment system 120 features a touch screen display that is capable of mirroring the display of the mobile device 110. Furthermore, the audio and infotainment system 120 includes both voice audio controls, as well as, virtual and physical buttons to allow operation of features of the mobile device via the vehicle's controls once inside the vehicle. Therefore, incoming calls, text messages, and the like from the mobile device 110 can be redirected through the vehicle's audio and infotainment system such that these communications can be read or displayed to the driver using the vehicle's audio and infotainment systeth 120. Similarly outgoing calls, text messages, etc. can be controlled by the driver's voice via the vehicle's audio and infotainment system 120. These hands free features allow the driver to more safely operate the vehicle, because these features allow the diver to be more focused on driving while using features of the mobile device 110.

Unfortunately some drivers may be reluctant to use these hands free safety features and may opt to operate the mobile device 110 by hand while driving the vehicle. In order to address this safety hazard, the audio and infotainment system 120 can include applications for sensing the presence of the driver's mobile device 110 in the vehicle. Once inside the vehicle and during operation of the vehicle after a predetermined time period and/or after the vehicle reaches a predetermined velocity; the audio and infotainment system 120 can essentially “take over” the mobile device 110 by locking out some of its input interfaces. Thus, the only way that the mobile device 110 can be used in the vehicle while the vehicle is in operation, is via the vehicle's audio and infotainment system 120 controls.

The audio and infotainment system 120 can employ further control and encourage safer vehicle operation by requiring certain actions before certain features of the audio and infotainment system 120 become available to the driver. For example, radio, compact disk, or other stereo or audio features of the audio and infotainment system 120 may be locked out for a period of time if the driver attempts to operate the vehicle without first pairing and storing the mobile device 110 within the vehicle. This “lock out” feature is a punitive “stick” that is used to encourage drivers to only operate their mobile device in hands free mode using the vehicle's input controls. The amount of time the stereo functionality may be locked out can be user adjustable, but it is ideally long enough to encourage the driver to always pair their mobile device 110 with the audio and infotainment system 120 for hands free operation. In an alternative embodiment, the vehicle's audio and infotainment system 120 can play an audio or video safety message to the driver until the mobile device 110 is stored and paired with the vehicle.

Similar to the discussion above, the audio and infotainment system 120 may lock out or mute its stereo and audio features if the driver attempts to operate the vehicle without first engaging the vehicles safety systems 140. For example, if a driver attempts to drive the vehicle without engaging their seatbelt, the audio and infotainment system 120 may “lock out” the stereo control until the seatbelt is engaged. Alternatively, the stereo features may be locked out for a predetermined period of time. The system 100 may also mute the audio or limit the audio volume to a lower maximum threshold as a punitive measure for the driver. In another embodiment, the vehicle's audio and infotainment system 120 can play an audio or video safety message until the driver and/or passengers engage their seatbelts or other safety systems. The vehicle safety system 140 may employ sensors to ensure that the safety restraint system is properly engaged. For example, to make sure the driver and or passengers are actually using their seatbelts, the vehicle safety system 140 can include sensors for measuring the amount of seatbelt material used relative to the weight and height of a passenger in a particular seat to determine if a driver or passenger are actually using the seatbelt; versus simply engaging the seatbelt and sitting “atop” the seatbelts. If the vehicle safety system 140 determines the driver and/or a passenger are not properly restrained, the integrated vehicle safety system 100 can initiate punitive measures by locking out the stereo controls for a predetermined period of time as explained above. These punitive measures are to encourage the driver and passengers to engage their seatbelts once they are inside the vehicle.

In a further embodiment, the integrated vehicle safety system 100 can also record driver operation of the vehicle by gathering vehicle diagnostic and performance data from the vehicle's diagnostic systems 150. The integrated safety system 100 can also gather GPS data related to tracking the vehicle's location or for determining driver operation of the vehicle using either GPS data from the vehicle or the mobile device 110. This would allow the integrated safety system 100 to provide driver feedback regarding driving habits and performance. Vehicle performance data can be transmitted to the driver's mobile device 110 via wireless or wired connections to the vehicle's audio and infotainment system 120. In an alternative embodiment, an aftermarket accessory is attached the vehicle's diagnostic port 150 for gathering vehicle performance data and for transmitting this vehicle performance data wirelessly or wired to the driver's mobile device 110.

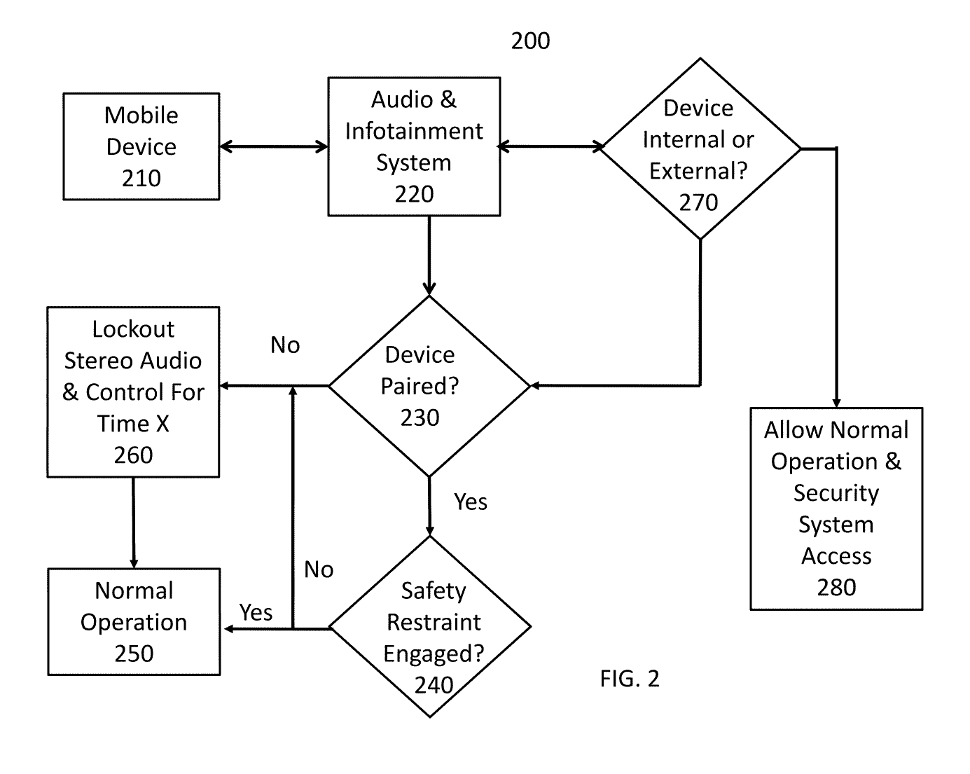

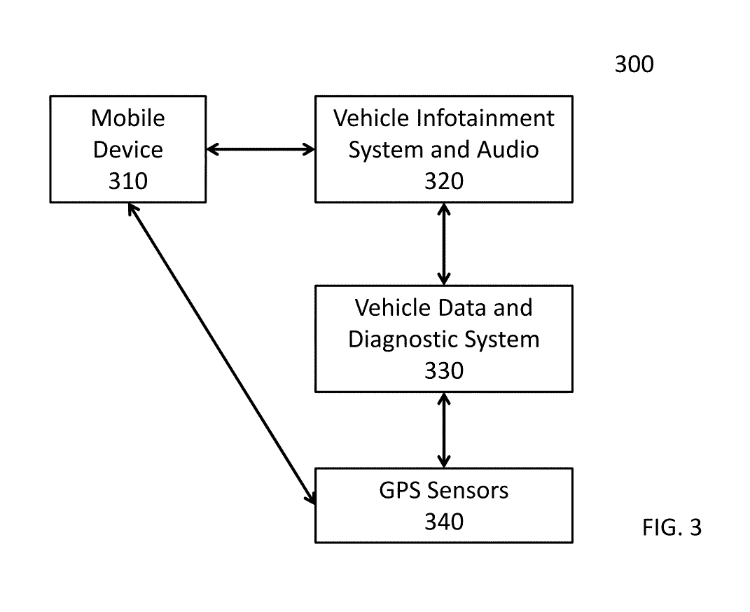

The integrated vehicle safety system 100 can prevent a driver from operating their mobile device during operation of the vehicle by employing a mobile device management system 200 as illustrated in FIG. 2. The mobile device management system 200 can be a software application executing on, or an API within, the mobile device's 210 operating system as well as the vehicle's audio and infotainment operating system 220.

At step 270, the mobile device management system can employ sensors within the vehicle to determine if the mobile device 210 is internal the vehicle or external to the vehicle. If the mobile device 210 is external to the vehicle 280, the mobile device is allowed to both operate normally and to control the ignition and security features of the vehicle. However, if the mobile device 210 is internal to the vehicle, the mobile device management system 200 determines the mobile device 210 has been paired with the vehicle such the vehicles controls can be used to operate the mobile device. To further encourage mobile device 210 paring with the vehicle, the mobile device 210 may include an application that allows the mobile device 210 to act as an ignition and/or door key for the vehicle. In an exemplary embodiment, there is a grace period for pairing and storing the mobile with the vehicle. The length of this grace period can be user adjustable. The grace period may also be tied to velocity of the vehicle. For example, if the vehicle is being driven over a threshold velocity, for example 10 miles per hour, the mobile device management system 200 may require the mobile device 210 to be paired with the vehicle for control. Of course, the actual threshold vehicle velocity can be user adjustable and predetermined. If the mobile device 210 is not paired with the vehicle prior to reaching the threshold velocity or prior to a predetermined time period, the mobile device management system 200 can lock out stereo audio controls for a predetermined period of time 260 as a punitive measure as explained above. In contrast, if the system 200 determines that the mobile device 210 is paired with the vehicle's audio and infotainment system 220, then the system moves on to step 240.

At step 240 the mobile device management system 200, uses the vehicle's safety restraint system 240 to determine if the driver and/or passenger's seat belts are properly engaged. If these safety systems are engaged, the system moves on step 250 which allows normal operation of the mobile device 210 via the vehicles audio and infotainment system 220 controls. However, if these safety systems are not engaged, the system 200 locks out control of certain stereo and/or other features of the audio and infotainment system for a predetermined period of time at step 260.

The integrated vehicle safety system 100 can also encourage better driver behavior by measuring driver performance and providing driver feedback using a driver data recording system 300 as illustrated in FIG. 1 Here the mobile device 310 is paired with the vehicle's audio and infotainment system 320 during operation of the vehicle. The system 300 gathers data from the vehicles diagnostic system 330 as well data from GPS sensors 340 within the mobile device and/or vehicle. This gathered data could be stored in the vehicle's audio and infotainment system 320 and/or transferred to the mobile device 310 for analysis of driver performance, habits and/or behaviors. This data can further be used to track a driver's location both dynamically and historically.

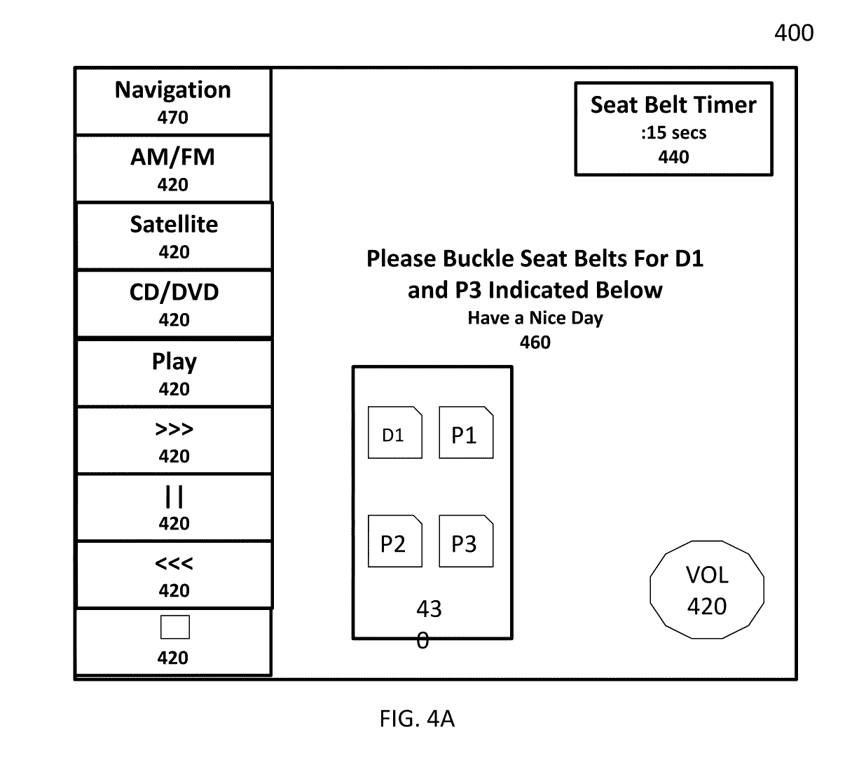

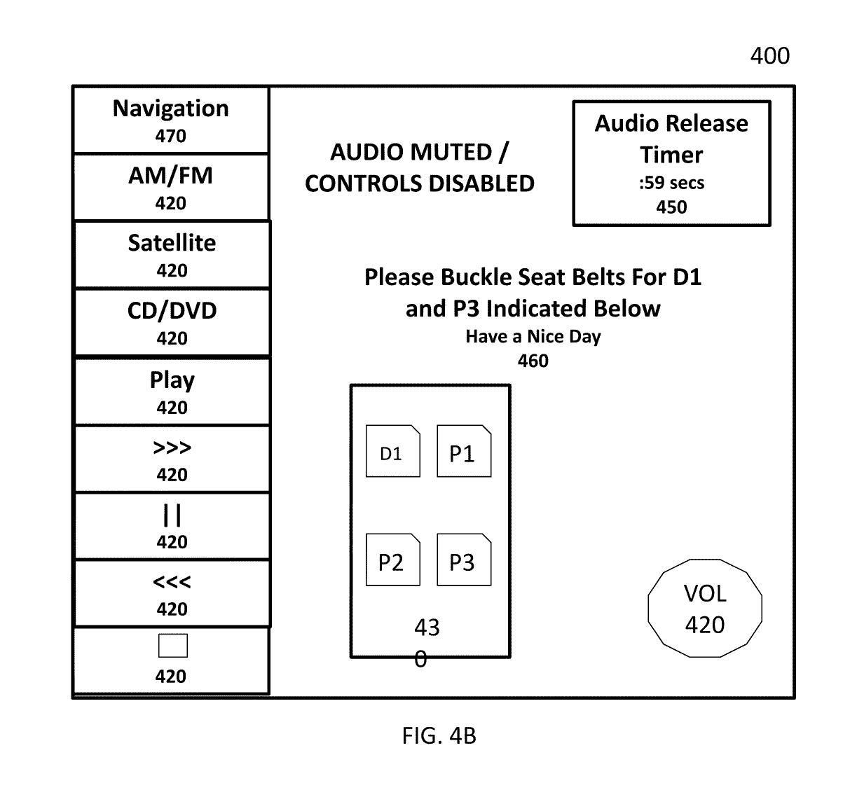

FIGS. 4A-4B illustrate an exemplary embodiment of the integrated vehicle safety system 100, wherein the audio and infotainment system 400 includes a display screen 410 for communicating and interacting with a driver. In an exemplary embodiment, the display screen 410 is a touch screen computer display as is known in the art. In an embodiment, the audio and infotainment system 400 initially warns a driver and/or selected passengers to buckle their seat belts by illustrating the seating positions (here D1 and P3) were proper seat belt use is required 430 and providing a count down timer 440 for requiring seatbelt use. If the driver and/or offending passenger fail to buckle their seatbelts within the required amount of time and/or at the threshold velocity, the system 400 disables the vehicles audio system 460. Therefore, the vehicle's audio controls 420 become non-responsive during this time and the stereo system's audio may be muted as described above. The vehicle's audio system 460 remains disabled for a period of time as indicated by a countdown timer on the display. The goal is to encourage good driver and passenger safety behavior by using these punitive measures.

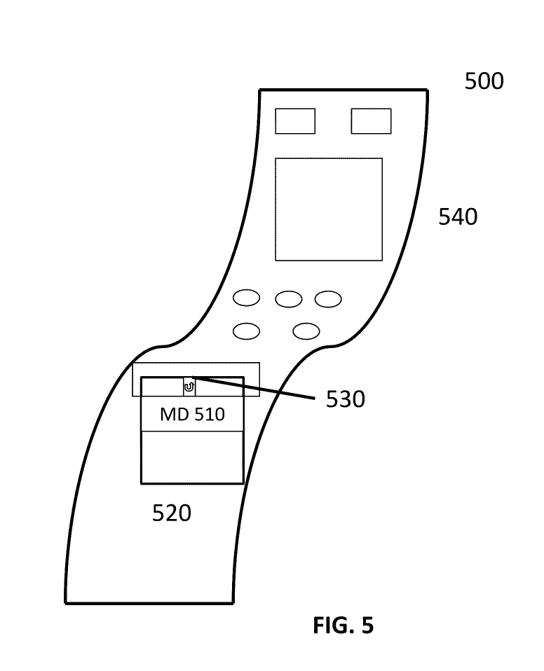

FIG. 5 illustrates a further embodiment of the integrated vehicle safety system 100. The system 100 can further encourage safer use of a mobile device in a vehicle by requiring the mobile device 510 to be stowed within a compartment 520 that is integrated into the vehicle. The storage compartment 520 may include a hardware connector 530 comprising a universal serial bus (USB), Firewire (IEEE_{—}1394), Thunderbolt®, Peripheral Component Interconnect Express (PCle), or any other hardware connector and the like for physically connecting the mobile device 510 to the vehicle. This compartment may be integrated into the dash 540 or other area of the vehicle. Once the device is connected to the hardware port 530 and stored in the compartment 520, it can be “paired” with the vehicle per the discussion in FIG. 2 above. The hardware connector may further be used to transfer data between the mobile device 510 and the integrated safety system 100, as well as provide power to the mobile device 510.

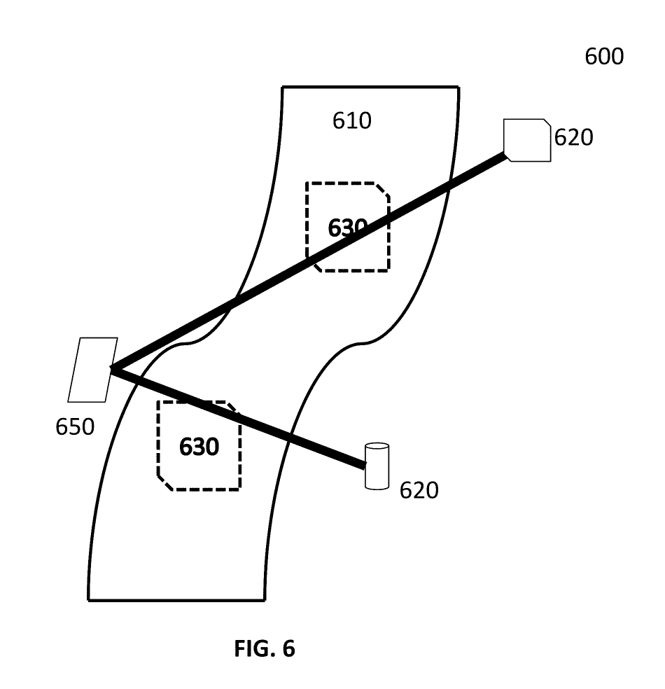

FIG. 6 further illustrates an embodiment of the sensors 600 associated with the vehicle's safety systems 140 as discussed above. In an exemplary embodiment, each seat 610 within the vehicle includes a seatbelt 640 for engagement with a latch 650. The latch 650 contains sensors for determining if the seatbelt has been engaged. However, simply engaging the seatbelt is not a complete indication that a driver or passenger has been properly restrained. Therefore, the vehicle safety system sensors 600 include a seat sensor 630 for measuring the weight and/or height of a passenger. This seat sensor 630 works in concert with a seatbelt material length sensor 620 that measure the length of seatbelt material being used to restrain a driver and/or passenger. The vehicle safety system 140 employees an algorithm that uses data from these sensors, 620, 630, 650 to determine a threshold range for the length of seatbelt material that should be used for an passenger of a determined size. If the length of seatbelt materials falls below the threshold range, the integrated safety system 100 can lock out the stereo controls as indicated above in FIG. 2. The punitive measures are employed to encourage safe operation of the vehicle.

Turning now to FIG. 7, one skilled in the art will appreciate that the systems and methods disclosed herein can be implemented via a general-purpose computing device in the form a computer 701. The components of the computer 701 can comprise, but are not limited to, one or more processors or processing units 703, a system memory 712, and a system bus 713 that couples various system components including the processor 703 to the system memory 712. In the case of multiple processing units 703, the system can utilize parallel computing.

The system bus 713 represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Private Branch Exchange (PBX) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 713, and all buses specified in this description can also be implemented over a wired or wireless network connection and each of the subsystems, including the processor 703, a mass storage device 704, an operating system 705, software 706, data 707, a network adapter 708, system memory 712, an input/output interface 710, a display adapter 709, a display device 711, a human machine interface 702, can be contained within one or more remote computing devices 714a,b,c at physically separate locations, connected through buses of this form, in effect implementing a fully distributed system.

The computer 701 typically comprises a variety of computer readable media. Exemplary readable media can be any available media that is accessible by the computer 701, comprising both volatile and non-volatile media, as well as, removable and non-removable media. The system memory 712 comprises computer readable media in the form of volatile memory, such as random access memory (RAM), and/or non-volatile memory, such as read only memory (ROM). The system memory 712 may contain data such as media, video, audio, or other data 707 and/or program modules such as operating system 705 and software 706 capable of manipulating, translating, transcoding, or otherwise editing the data 707 that are immediately accessible to and/or presently operated on the by the processing unit 703.

In another aspect, the computer 401 can also comprise other removable/non-removable, volatile/non-volatile computer storage media. By way of example, FIG. 7 illustrates a mass storage device 704, which can provide non-volatile storage of computer code, computer readable instructions, data structures, program modules and other data for the computer 701. For example, a mass storage device 704 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 704, including by way of example, an operating system 405 and integrated safety system software 706. Each of the operating system 704 and mobile device management software 706 (or some combination thereof) can comprise elements of the programming and the mobile device management software 706. Media, video, audio, or other data 707 can be stored in any of one or more databases known in the art. Examples of such databases comprise, DB2®, Microsoft® Access, Microsoft® SQL Server, Oracle®, MySQL, PostgreSQL, and the like. The databases can be centralized or distributed across multiple systems.

In another aspect, the user can enter commands and information into the computer 701 via client device or an input device (not shown). Example of such input devices comprise, but are not limited to, a keyboard, pointing device (e.g., a “mouse”), touch screen, a microphone, a joystick, a scanner, tactile input devices such as gloves, and other body coverings, and the like. These and other input devices can be connected to the processing unit 703 via a human machine interface 702 that is coupled to the system bus 713, but can be connected by other Interface and bus structures, such as a parallel port, game port, and IEEE 1394 Port (also known as a Firewire port), a serial port, or a universal serial bus (USB).

In yet another aspect, a display device 711 can also be connected to the system bus 713 via an interface, such as a display adapter 709. It is contemplated that the computer 701 can have more than one display adapter 709, and the computer 701 can have more than one display device 711. For example, a display device can be a monitor, an LCD (Liquid Crystal Display), or a projector. In addition to the display device 711, other output peripheral devices can comprise components such as speakers (not shown) and a printer (not shown), which can be connected to the computer 701 via input/output interface 710. Any step and/or result of the methods can be output in any form to an output device. Such output can be any form of visual representation, including but not limited to, textual, graphical, animation, audio, tactile, and the like. The display 711 and computer 701 can be part of one device or separate devices.

The computer 701 can operate in a networked environment using logical connections to one or more remote computing devices 714a,b,c. By way of example, a remote computing device can be a personal computer, portable computer, smartphone, softphone, client device, a server, a router, a network computer, a peer device or other common network node, and so on. Logical connections between the computer 701 and remote computing device 714a,b,c can be made via a network 715, such as a local area network (LAN) and or a general wide area network (WAN). Such network connections can be through a network adapter 708. A network adapter 708 can be implemented in both wired and wireless environments. Such networking environments are conventional and commonplace in dwellings, offices, enterprise-wide computer networks, intranets, and the Internet.

For purposes of illustration, application programs and other executable program components such as the operating system 705 are illustrated herein as discrete blocks, although it is recognized that such programs and components reside at various times in different storage components of the computing device 701, and are executed by the data processor(s) of the computer. An implementation of media manipulation software 706 can be stored on or transmitted across some form of computer readable media. Any of the disclosed methods can be executed by computer readable instructions embodied on computer readable media. Computer readable media can be any available media that can be accessed by a computer. By way of example and not meant to be limiting, computer readable media can comprise “computer storage media” and “communications media.” “Computer storage media” comprises volatile and non-volatile, removable and non-removable media implemented in any methods or technology for storage of information such as computer readable instructions, data structures, program modules, or other data. Exemplary computer storage media comprises, but is not limited to RAM, ROM, EEPROM, flash memory or memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ Artificial Intelligence (Al) techniques such as machine learning and iterative learning. Examples of such techniques include, but are not limited to, expert systems, case-based reasoning, Bayesian networks, behavior-based Al, neural networks, fuzzy systems, evolutionary computation (e.g. genetic algorithms), swarm intelligence (e.g. ant algorithms), and hybrid intelligent system (e.g. expert interference rules generated through a neural network or production rules from statistical learning).

In the case of program code execution on programmable computers, the computing device-generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an Application Programming interface (API), reusable controls, or the like. Such programs may be implemented in a high level procedural or object-oriented programming language to communicate with a computer system. However, the program(s) can be implemented in assembly or machine language. In any case, the language may be a compiled or interpreted language, and it may be combined with hardware implementations.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be affected across a plurality of devices. Such devices might Include PCs, network servers, mobile phones, softphones, and handheld devices, for example.

Although the subject matter has been described in language specific to structural features and/or methodological acts, it is to be understood that the subject matter defined in, the appended claims is not necessarily limited to the specific features or acts described above. Rather, the specific features and acts described above are disclosed as example forms of implementing the claims.

1. An integrated safety system for a vehicle comprising:
a vehicle audio and infotainment system, comprising a computing device with wired and wireless connection capabilities, wherein said vehicle audio and infotainment system is connected to a vehicle ignition system, a vehicle safety restraint system, a vehicle security system and a driver data recording system,
a mobile device having software code for connecting to the vehicle's audio and infotainment system, wherein said software code allows said mobile device to be authenticated with said vehicle such that said vehicle's ignition, security and audio and infotainment systems can be controlled via said mobile device;
a mobile device management system, such that
said mobile device is only operable within said vehicle via the vehicle's integrated audio and infotainment controls,
said mobile device can control certain vehicle ignition and security systems, and wherein said mobile device management system prevents the use of said audio and infotainment system if certain safety procedures are not engaged.

2. The integrated safety system of claim 1, wherein said vehicle audio and infotainment system features are inoperable unless said mobile device management system is engaged.

3. The integrated safety system of claim 1, wherein said vehicle audio and infotainment system is inoperable unless said vehicle safety restraint system is engaged.

4. The integrated safety system of claim 3, wherein said restraint system is contains sensors for determining if a passenger has properly engaged the restrain system before the audio and infotainment system becomes operable for a user.

5. The integrated safety system of claim 2, wherein said vehicle audio and infotainment system can include user adjustable punitive operational delays if said vehicle is driven without said mobile device management system or vehicle safety restrain systems engaged.

6. The integrated safety system of claim 1, wherein said mobile device management system comprises software code for disabling handheld operation of certain features of said mobile device when said mobile device is within said vehicle.

7. The integrated safety system of claim 1, wherein said mobile device management system comprises software code for disabling handheld operation of certain features of said mobile device when said vehicle is in motion.

8. The integrated safety system of claim 1, wherein said mobile device management system comprises a integrated mobile storage unit for disabling handheld operation of certain features of said mobile device.

9. The integrated safety system of claim 1, wherein said mobile device management system comprises, driver data recording system for collecting vehicle performance data during vehicle operation.

10. The integrated safety system of claim 9, wherein said driver data recording system can transfer vehicle performance data to said mobile device.

11. The integrated safety system of claim 1, wherein said vehicle audio and infotainment system, can connect to said mobile device via a wireless or wired connection.

12. The integrated safety system of claim 1, wherein said vehicle audio and infotainment system in connection with the mobile device management system, allows said mobile device to be operated via voice audio control during vehicle operation.

13. The integrated safety system of claim 1, wherein said vehicle audio and infotainment system in connection with the mobile device management system, can produce a cellular or wireless network jamming signal when the vehicle is in use.

14. A method for providing an integrated safety system for a vehicle comprising:
integrating an audio and infotainment system having a computing device with wired and wireless connection capabilities with a vehicle ignition system, a vehicle safety restraint system, a vehicle security system and a driver data recording system,
connecting said audio and infotainment system to a mobile device via a wireless or wired connection,
authenticating a mobile device with said audio and infotainment system such that said vehicle's ignition, security, audio and information systems can be controlled via said mobile device;
executing within the computing device of the audio and infotainment system, software code for a mobile device management system, such that
said mobile device is only operable within said vehicle via the vehicle's integrated audio and infotainment controls,
said mobile device can control certain vehicle ignition and security systems, and wherein said mobile device management system prevents the use of said audio and infotainment system if certain safety features and procedures are not engaged.

15. The method of claim 14, wherein said restraint system is contains sensors for determining if a passenger has properly engaged the restrain system before the audio and infotainment system becomes operable for a user.

16. The method of claim 14, wherein said vehicle audio and infotainment system can include user adjustable punitive operational delays if said vehicle is driven without said mobile device management system or vehicle safety restraint systems engaged.

17. The method of claim 14, wherein said mobile device management system comprises software code for disabling handheld operation of certain features of said mobile device when said mobile device is within said vehicle.

18. A computer program stored one or more computer-readable storage devices and executing on a computing device for providing an integrated safety system for a vehicle comprising:
software code for integrating an audio and infotainment system having wired and wireless connection capabilities with a vehicle ignition system, a vehicle safety restraint system, a vehicle security system and a driver data recording system,
software code for connecting said audio and infotainment system to a mobile device via a wireless or wired connection,
software code for authenticating a mobile device with said audio and infotainment system such that said vehicle's ignition, security, audio and information systems can be controlled via said mobile device;
executing within the computing device, additional software code for a mobile device management system, such that
said mobile device is only operable within said vehicle via the vehicle's integrated audio and infotainment controls,
said mobile device can control certain vehicle ignition and security systems, and wherein said mobile device management system prevents the use of said audio and infotainment system if certain safety features and procedures are not engaged.

19. The computer program of claim 18, wherein said software code allows said vehicle audio and infotainment system to include user adjustable punitive operational delays if said vehicle is driven without said mobile device management system or vehicle safety restraint systems engaged.

20. The computer program of claim 18, wherein said mobile device management system comprises software code for disabling handheld operation of certain features of said mobile device when said mobile device is within said vehicle.
